(19) United States
(12) Patent Application Publication
(10) Pub. No.: US 2026/0057456 A1
(43) Pub. Date: Feb. 26, 2026

(54) METHOD AND APPARATUS FOR IN SITU MEASURING AGE OF SCLERITES

(71) Applicants: James D. Allen, La Grange, KY (US); Robert D. Lusk, Whitesboro, TX (US); Gerald D. Allen, Cadiz, KY (US)

(72) Inventors: James D. Allen, La Grange, KY (US); Robert D. Lusk, Whitesboro, TX (US); Gerald D. Allen, Cadiz, KY (US)

(21) Appl. No.: 19/295,428

(22) Filed: Aug. 8, 2025

Related U.S. Application Data
(60) Provisional application No. 63/685,660, filed on Aug. 21, 2024.

(51) Int. Cl. G06Q 50/02; G06V 10/141

(52) U.S. Cl. CPC G06Q 50/02; G06V 10/141; Y02A 40/81

(57) ABSTRACT

The present disclosure provides a fish scale imaging device and method for in situ imaging fish scales and estimating an age of a fish. The imaging device is configured to image a fish scale in situ. The imaging device comprises a first extension configured and disposed to be placed under the in situ fish scale being imaged, a second extension extending proximate the first extension, and a gap space between the first extension and the second extension. The gap space is sufficient to receive the in situ fish scale and the imaging device has an imager configured and disposed to image patterns within the in situ fish scale.

### CROSS REFERENCE TO RELATED APPLICATIONS

This application claims priority to U.S. Provisional Patent Application Ser. No. 63/685,660, filed on Aug. 21, 2024, entitled “METHOD AND APPARATUS FOR MEASURING AGE AND IDENTITY OF SCLERITES”, which is incorporated by reference herein in its entirety.

### FIELD OF THE DISCLOSURE

This disclosure relates generally to a method and apparatus for measuring age related characteristics of sclerites, specifically scales of fish, for the purpose of determining age.

### BACKGROUND

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

Fisheries managers have a variety of methods for managing fish. Typically, managing requires a sample of fish obtained by methods including electroshocking, netting and angling. With reference to FIG. 1, the length and weight of fish may be recorded or plotted 100 and their ratio compared to an empirically determined species-specific expectation of their Length to Weight Ratio as described by Neumann and Murphy. This Ratio is referred to as Relative Weight, Wr. Wr for each fish is compared to a Wr Standard 110, which was derived from many years of measurements. The measured fish can be numerically or graphically displayed, one fish, for example, can be graphed as a data point 105. Fish longer than the Wr Standard length 110 for their weight, e.g., 130, are considered less healthy than fish that are shorter than the Wr Standard for their weight, e.g., 120. There may be many reasons for being above or below the Wr Standard 110, and a range of deviation such as illustrated by 140 and 150 are expected. This data helps the fisheries manager understand what's happening to the fish population. Each fish's length and weight data may be collected as soon as it's sampled, after which the fish may be released unharmed. Wr data over multiple samples or years is also important for determining long-term trends. This represents the state of the art.

Another tool used by fishery managers is the population distribution of size 200. The tool illustrated in FIG. 2A indicates the relative number of fish in each size length commonly referred to as a “class” or grouped into “classes”. Fifteen-inch fish 210 are the most common class in this sample. The average age of the population, or the age of a specific fish is not represented.

Fish have relatively short lifespans. A change in their environment may slow their growth rates so they may not live long enough to recover their maximum potential length during their lifetimes. For an example, a Largemouth Bass in a specific body of water may have an average lifespan of twelve years and may grow to be in excess of 20 inches long. In this example 200, a sample of fifteen-inch Bass 210 are determined to have Relative Weights Wr within acceptable deviations 140 150 from the Wr Standard 110. They all appear to be healthy. However, if one of those fifteen-inch fish is eight years old, it is not as likely to fulfill its maximum potential size as the younger fish of the same Wr. If a fisheries manager has age information in real time, they may choose to cull that fish to allow the younger fish access to more food that is fit for its class. With fewer mouths to feed, that is less competition, the younger fifteen-inch have a better chance of growing larger, faster. Even if the fish is not culled, its data is an important aspect of managing a fishery.

The tool can also be used over time to indicate how the fish population is growing and changing the demand on the food chain, which changes as fish grow and their mouths accommodate larger prey. FIG. 2B 200 illustrates information as FIG. 2A 200 including the fifteen-inch fish class 210 over time. The data is shown as trend line and includes two additional years of normalized population distributions for a specific body of water. The trend lines illustrate one year in the past 205, a current year 200 and for illustrative purposes a future year 215. The general population of fish is shown to be moving up in size. For example, the current year 200 has a peak population 210 of fifteen-inch Bass. The next year has a peak 215 around eighteen-inch Bass. The data may be used to help determine the effects of management methods.

Using age in real time as a fishery management tool may be very important. However current methods for determining the age of a fish may either kill the fish or take hours to weeks to obtain. In one common method, the fish is killed and its inner ear bone, the Otolith, is removed. The Otolith's growth rings are analyzed under a microscope to determine its age. The other common method requires the removal of typically 3 to 5 scales (sclerites) from above the fish's lateral line, near the head. The scale undergoes similar analysis, but is not as easy to accurately analyze as the Otolith. Scale removal is similar to removing a human fingernail and does not kill the fish. Both methods may be labor and time intensive.

### SUMMARY

The present disclosure provides an apparatus and method for measuring sclerites in situ in animals, including fish scales for the purpose of determining the age and optionally a unique identification for the sclerite, or the animal to which it belongs.

The present disclosure may solve or mitigate one or more of the aforementioned challenges or problems. The presently disclosed fish scale imaging device and method includes using digital electronic scanning methods in an apparatus or fish scale imaging device designed to slip under in situ scales of a living fish and estimate the fish's age in real-time, that is, during the sampling process. In situ scanning means that scale is left in place on the live fish and is measured with minimal negative effect. The apparatus estimates age by electronically scanning the event (growth) rings within its scales. This provides the fisheries manager additional data with which to make on-the-spot decisions about the future of each sampled fish. The data may also be used to manage trends of the larger fish population, and the trends of the fish population over multiple seasons or surveys.

The device or apparatus may provide data for estimating a fish's age by electronically scanning the event (growth) rings within its scales. This provides the fisheries manager additional data with which to make on-the-spot decisions about the future of each sampled fish. The data may also be used to manage trends on the larger fish population, and the trends of the fish population over multiple seasons or surveys.

In at least one aspect of the present disclosure, a fish scale imaging device configured to image a fish scale in situ is disclosed. The imaging device comprises a first extension configured and disposed to be placed under the in situ fish scale being imaged, a second extension extending proximate the first extension, a gap space between the first extension and the second extension, the gap space being sufficient to receive the in situ fish scale therebetween, and an imager configured and disposed to image patterns within the in situ fish scale.

In another aspect of the present disclosure, a method of estimating an age of a fish is disclosed. The method comprises placing a first extension of an imaging device under a first in situ fish scale; placing a second extension of the imaging device over the first in situ fish scale and disposing the first in situ fish scale between the first extension and the second extension; imaging the first in situ fish scale; detecting and analyzing event rings in the image of the first in situ fish scale; and estimating the age of the fish based on the detected and analyzed event rings.

### DESCRIPTIONS OF THE DRAWINGS

The following figures, which are idealized, are not to scale and are intended to be merely illustrative of aspects of the present disclosure and non-limiting. In the drawings, like elements are depicted by like reference numerals. The drawings are briefly described as follows.

FIG. 1 illustrates a Weight/Length plot for a sample of fish;

FIG. 2A illustrates a normalized population of sampled fish by length;

FIG. 2B illustrates trend curves for three years of normalized population of sampled fish by length;

FIG. 3 illustrates an example of scales for a Ctenoid fish, show here as a Largemouth Bass;

FIG. 4A illustrates the detail of a scale, showing dark event ring bands and a reference center line;

FIG. 4B illustrates the detail of a scale, showing light event ring band and a reference center line;

FIG. 4C is a microscope photomosaic of an extracted Largemouth Bass scale;

FIG. 5 illustrates key attributes of a typical Ctenoid fish;

FIG. 6 illustrates a thickness cross section of a scale along a center line;

FIG. 7 illustrates an optical scanner embodiment of the fish scale imaging device;

FIG. 8 illustrates the positioning of a scanner sensor with respect to a scale;

FIG. 9A illustrates a capacitance scanner embodiment of the fish scale imaging device;

FIG. 9B illustrates a closer view of the a capacitance scanner shown in FIG. 9A;

FIG. 10 illustrates a system configured to determine the age of a fish; and

FIG. 11 illustrates an embodiment with scale alignment indices.

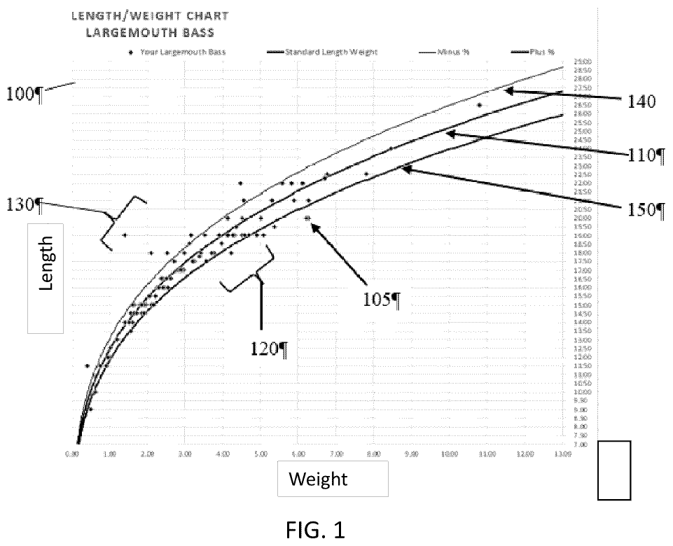

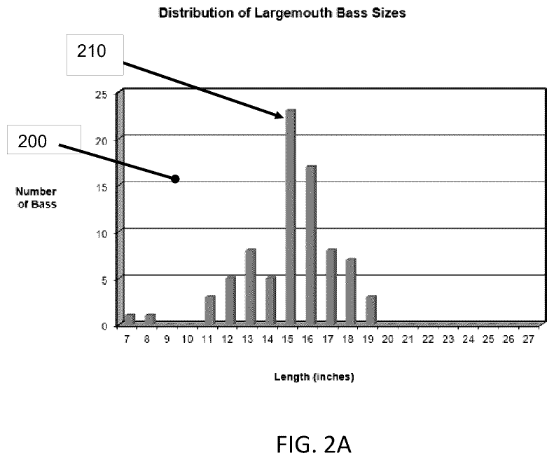

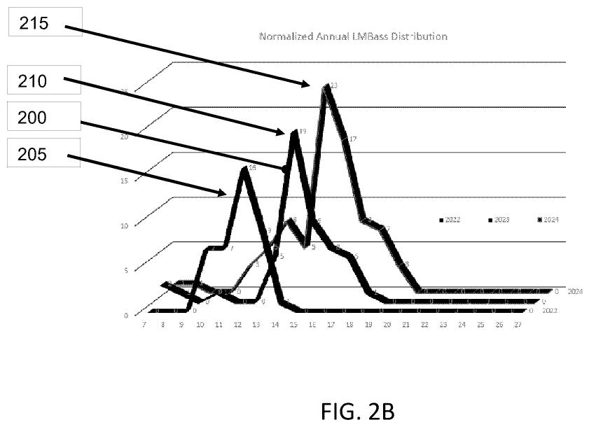

### DETAILED DESCRIPTION

The Oxford dictionary defines a Sclerite as “A component section of an exoskeleton, especially each of the plates forming the skeleton of an arthropod”. Fish are not arthropods, but the term is used in the scientific discussion of plates, including fish scales. This disclosure applies to fish and any arthropod with event rings in its exposed sclerites. However, the terms “fish scale” or “scale” are used in this description.

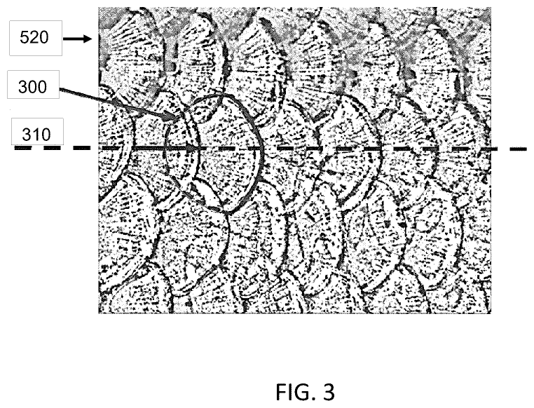

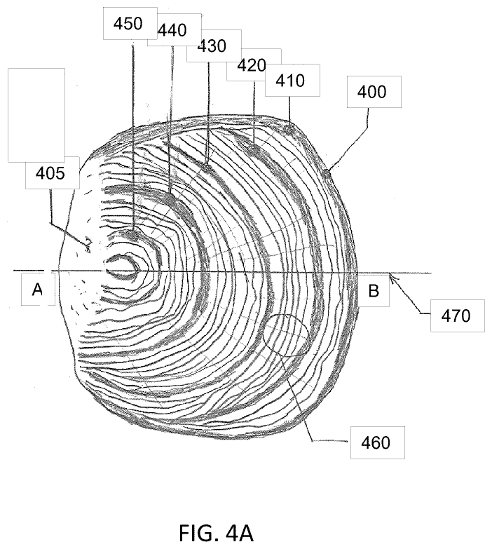

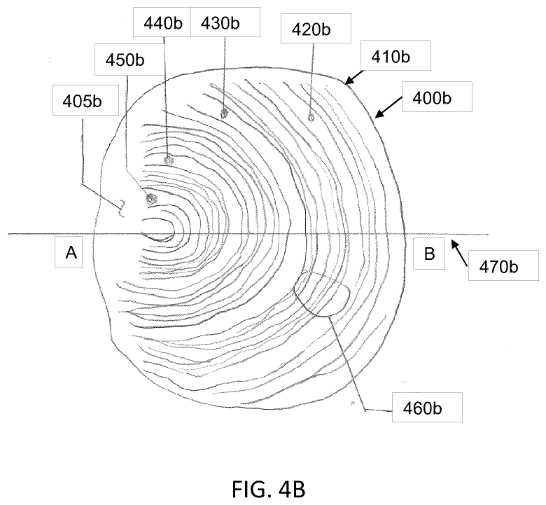

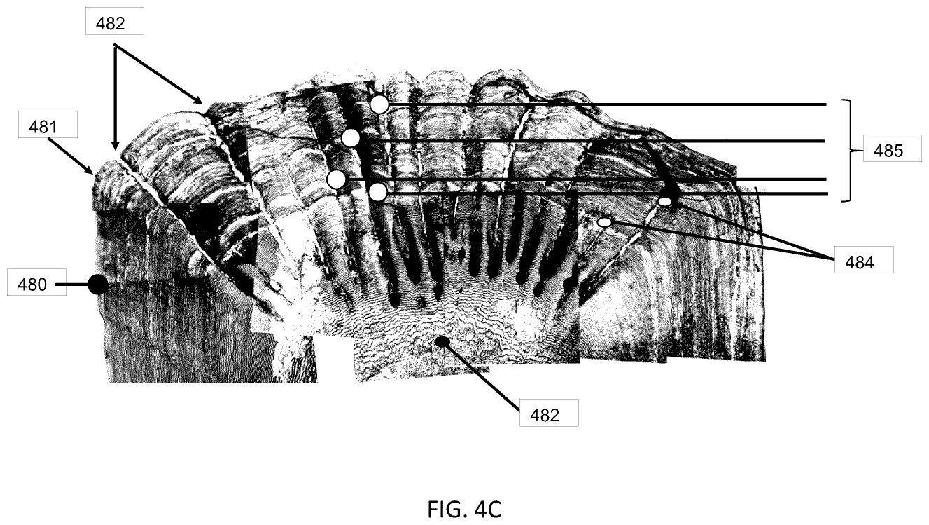

FIG. 3 illustrates typical scales of a ctenoid fish. The presently disclosed method may be most suitable for cycloid and ganoid fish as well, but the preferred application may be freshwater game fish, such as Largemouth Bass. The scales overlap along the fish's length axis, 320. For example, one end is embedded in the skin, proximate a nose of the fish, and the rest of the scale is relatively free to flex about an adjacent scale proximate a tail of the fish, as shown 300. As a fish grows, the density or composition of a scale changes in response to its environment and forms rings called circuli. Groups of circuli record growth events over time. Cyclic events such as changes in the seasons may be seen as cyclic changes in the pattern of circuli as grouped 460, FIG. 4A, and referred to herein as event ring bands. For example, in cold weather, a fish may grow slower and the circuli pile up close to each other and appear as denser event rings 410, 420, 430, 440, 450. The group of circuli contained within the cyclical event is called herein an Event Ring Band. If the Event Rings are seasonal, one band per year, the Event Ring Band is also referred to as annuli. Conversely, warm-water fish (e.g. fish from southern climates) grow faster in the spring and slower in hot weather. Rather than the dark Event Rings in FIG. 4A, the Event Ring Bands may be detected by lighter bands as illustrated in FIG. 4B, 410b, 420b, 430b, 440b, and 450b. The event ring band in this case is determined as a group of circuli and illustrated as 460b. FIG. 4C shows an example of a warm-water fish scale. This scale was extracted and has a slightly different shape that those that are in situ.

There are many factors that may affect the event rings including, but not limited, to access to food, weather, and water quality. Annual events such as seasons can create repetitive annual event rings making it possible to estimate the scale's age and infer the fish's age. Knowing about the fish environment helps to determine how many bands my constitute one year. FIG. 4A illustrates a scale 400 and event rings that start at the nucleus 405 and expand out to the edge 410 with time. Annual event rings are illustrated, the oldest first year 410, second year 420, third year 430, fourth year 440 and the newest fifth year 450 event rings. There are also many smaller event rings (circuli) between the annual event rings. The entire collection of event rings in a cyclic pattern is an event ring band 460. Each fish's specific pattern is unique to that fish based on its life events and may even indicate the identity of specific fish.

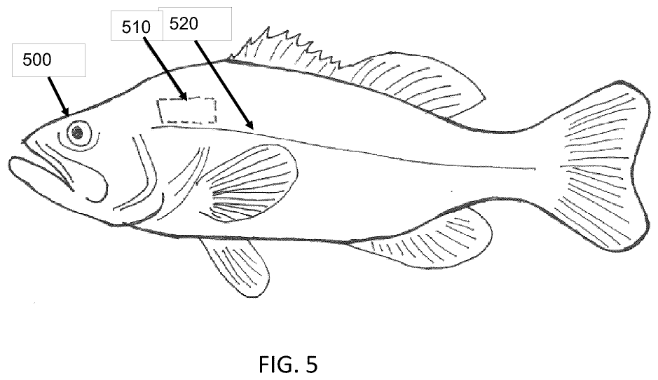

Scales may also differ based on where they occur on a fish's body, or how old the scale is, such as if a scales is lost and regrown. It is a best practice to choose one area of the fish to ensure the most consistent scans and that can access the center line of the scale 470. FIG. 5 shows an area 510 on a Bass 500 which tends to have the largest and oldest scales, containing the most information and consequently the best to be scanned. The best scale location may change for different species. Although the best scale location may be the lateral line 520 itself, also known as the lateral line organ, it contains sensory organs fish use to detect movement, vibration and pressure gradients in the surrounding water and should be avoided simply to minimize damage to the fish. Each scale may be scanned and analyzed multiple times, and several scales may be scanned in order to reach the best consensus of age. Best practices may be three to five scans of three to five scales. The scanned scales may be analyzed along a line 310 or radially from the nuclei, in order to get consistent scan data, however, the analysis, especially as by Artificial Intelligence, need not conform to set rules. The simple sequence number of each scale being scanned may be recorded and used by user interface software to provide acoustical, visual, or tactile feedback indicating when each scan or enough data is collected, and by the analysis software and hardware.

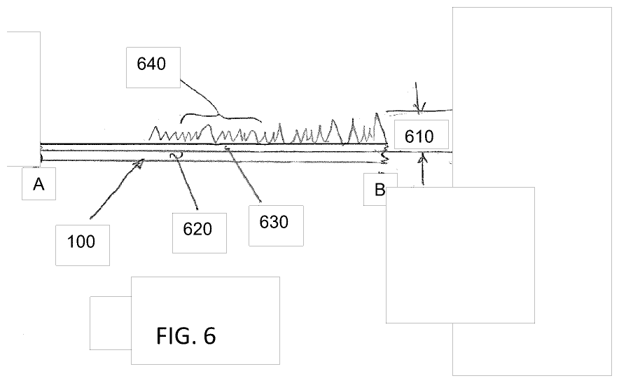

The event rings are created by variations including scale density, close spacing of multiple event rings, variations in transmissivity, reflectivity, color, and thickness. Scale construction varies per species, but for Bass a layer of collagen 620 about 1,000 microns thick forms a base, covered by layer of minerals 630 varying in thickness from 200 microns to 600 microns. This variation in thickness is shown with the thicknesses at 630 and 610. For example, the event rings from scale 410, along line A-B 470 are mapped onto FIG. 6 as thickness 640.

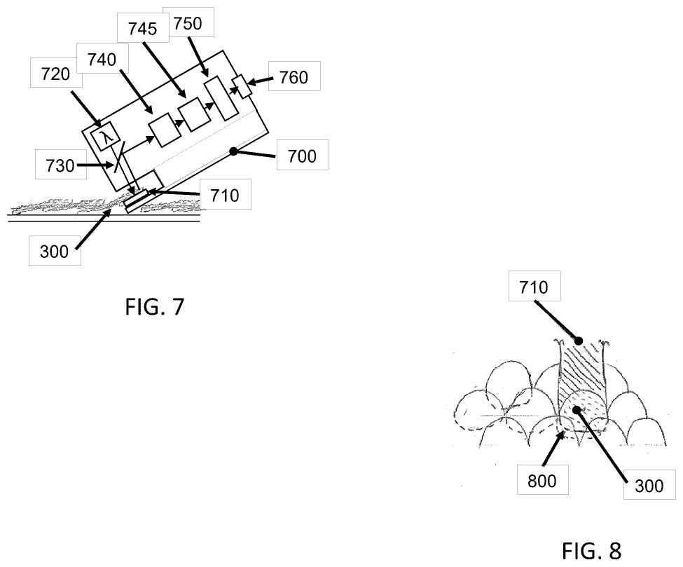

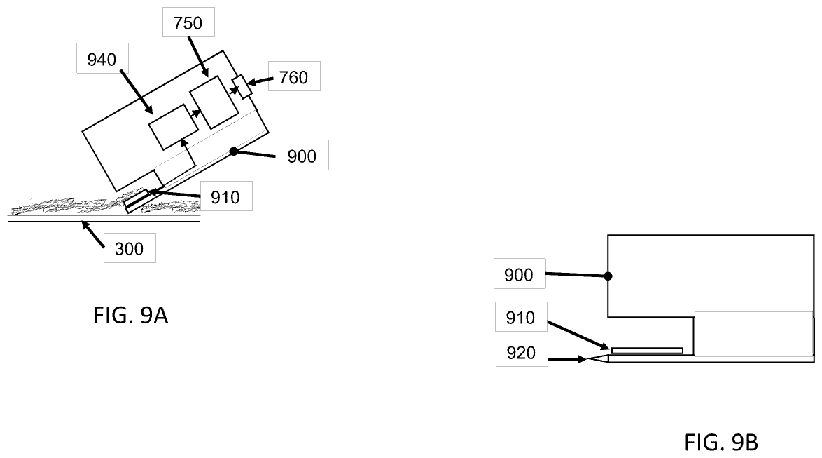

The present disclosure may use both spacings and shapes in the imaging and analysis of the of the fish scales. In at least one embodiment, the apparatus or fish scale imaging device 700, shown in FIG. 7, comprises an image scanner 740 and a scanner controller 745, pre-processer 750, and communication port 760. Illumination is provided by a light source 720, such as an LED, and is projected through a light splitter 730 onto the scale 300. The light is reflected from a reflecting surface 710, such as a polished mirror, inserted under the scale and into the optical imager 740, controlled by scanner function controller 745. Optical imager 740 captures event ring image data which is processed by a preprocessor 750 and communicated, via communication port 760, to a processing module, detailed below. The reflecting surface may be spring-loaded or otherwise adjustable in order to flatten the scale for scanning. The reflecting surface 710 is shaped to fit easily under the scale 300 and cover a large scale area. The tip of reflecting surface 710 may be rounded 800 which may reduce interference from neighboring scales or mitigate damage to the scale nuclei 405. The light source 720 may be of variable wavelength and intensity in order to optimize the scanner's ability to image the scale. For example, the use of UV light to enhance the identification of event rings as disclosed in UA93940U, UA92970U, incorporated herein by reference, may be used. Also, the scales may be stained with UV, florescent, or visible dyes such as Betadine™ to enhance the imaging quality. This embodiment also anticipates imaging through a scale by replacing the reflective surface 710 and light source 720 with a light source mounted in place of reflective surface 710. It also anticipates reflecting off the scanner-side of the scale, or a combination of methods for acquiring a high quality image.

In another embodiment 900 a solid-state capacitance imaging sensor 910 may be used in place of the reflective surface 710, light source 720, light splitter 730 and optical imaging sensor 740. Each event line is caused by thickness or composition that varies the capacitance of the ring. FIG. 7 illustrates thickness, color or opacity, and capacitance across a section of a scale from A to B 470 in this embodiment, each event ring is represented by a change in capacitance. That capacitance is measured by a solid-state sensor 910 mounted on surface 920 in place of the reflective surface with sufficient resolution to resolve differences in the Event Rings. The sensor 910 and surface 920 are slid under the scale and provides an image of the event rings based on capacitance. The capacitance imaging surface may be spring-loaded or otherwise adjustable in order to flatten the scale for scanning.

In another embodiment, thickness gauge measurement techniques may be used including but not limited to ultrasonic sensors, laser displacement sensors, profile sensors, and optical micrometers. Scanning may be done in line imaging, sequential line imaging in conjunction with movement between the scanner and scale, or by area imaging.

In at least one embodiment, it is anticipated that scales may be removed from the fish, especially dead fish, and directly mounted in the scanner. Embodiments may include a sensor area cleaning and drying means. It is also anticipated that the apparatus may be configured to clip or “ear mark” a scale in order to indicate the fish or scale has been previously scanned.

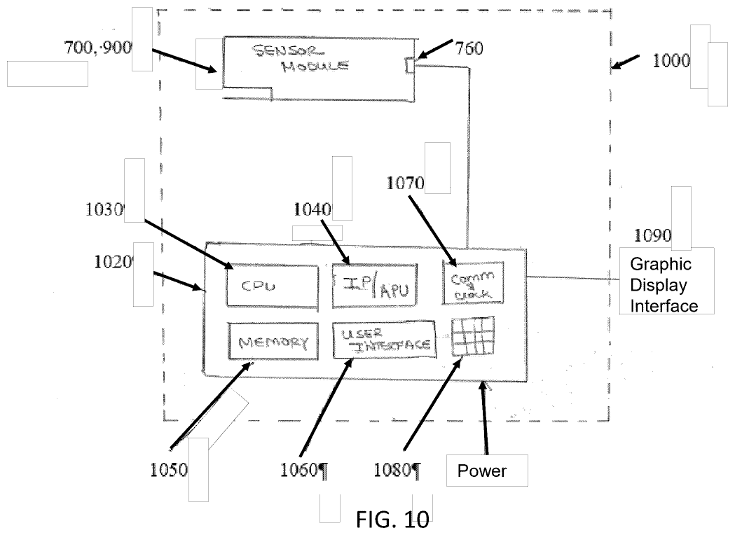

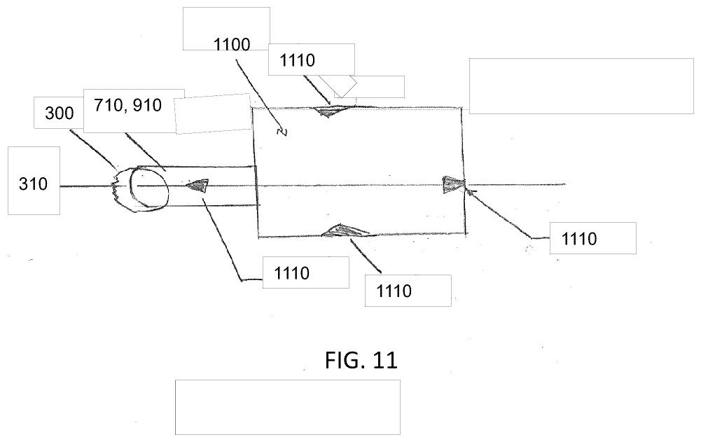

In at least one embodiment, a system 1000, FIG. 10, is configured to identify and determine the age of a fish may comprise scanner sensor 740, 910 connected to an image processor and sensor controller 745, 940 through an internal digital interface 760. The presently disclosed system may have an image processor, a sensor controller configured to control the sensor, a mechanical means to flatten the scale, and an illumination source. System 1000 may be configured to process the scan image information from imaging sensor 700, 900 and into a format that can be used by the processing module 1020 shown in FIG. 10. The processing module 1020 may be a computer, common in the art, and may be comprised of a scanner interface 760, a central processing unit 1030, memory 1050, power supply, control buttons 1080, control interfaces 1060, display and or graphic display interface 1090, and communications interfaces such as but not limited to USB, or ethernet 1090. The apparatus may be an application-specific device, or as part of a smart phone, or other computer device.

The central processing unit 1030 and imaging processor unit 1040 may be configured to process the sensor data to determine the number of annual event lines, that is, the scale's age. Several samples may be analyzed and the age is determined or estimated. System 1000 may have an algorithm or artificial intelligence, AI. The AI methods may make decisions on age with additional information entered via the user interface.

The data gathered from each scan may be stored in one or more datasets. For example, upon performing one or more scans of one or more scales, the age of the fish may be obtained and the scan data may be added to a unique dataset for that particular fish or location. Upon establishing a unique dataset, subsequent scale scans of that fish or location may be compared and similar areas aligned in order to fill in missing data or add additional data from other or older scales. System 1000 may be configured to determine the age or identity of the fish being scanned as requested by the user interface. Scan image data may be displayed on a digital display through the graphic display interface 1090 and interpreted by the user in real time. System 1000 may be configured to be controlled by a human interface 1080. Interface 1080 may be used to enter other useful data or notes such as, but not limited to, location, date, client, weather report, DNA data. Location may be important because southern fish without winters may require different algorithms than northern fish to detect annual event ring patterns. Information may also be gathered through control interfaces 1060. For example, GPS data may be gathered for automatically obtaining or recording location.

In cases where the scan is too difficult to electronically analyze, the scan image data may be displayed on a digital display through the graphic display interface 1090 and interpreted by the user. The device is controlled by a human interface 1080. The interface may also be used to enter other useful data such as, but not limited to, location, date, client, weather report, DNA data. In at least one embodiment, several scans and scans of several scales may be necessary. For example, as previously disclosed, if a scale has been lost and regrown, it will not contain the same history as older scales. Future scans will contain more information than the current or past scans. Also, damage to the scale may not be obvious to the observer. Therefore, the software may be configured to evaluate multiple images to estimate or determine age and identity. An example of this is “cross dating” in dendrochronology applications. In trees, climate changes can affect the growth of large areas of vegetation and be recorded in the tree ring growth. These climatic events can be used as time references for aligning ring samples from one tree or among samples from a forest of trees, and help identify proper scaling of the data, compensate for missing or extra rings, and aligning trees of different ages. Fish event rings (circuli and annuli) may be analyzed using a similar approach. One such method embodiment may replace dendrochronology's climatic events with shorter fish life span local environmental events such as, but not limited to, draught, or pollution, which may cause recognizable pattern changes in the growth rings.

In order to establish the age of an environmental event, careful records such as stocking dates and weather reports may be referenced and added to the analysis methods. However, it may be preferred to sample the Otolith from a statistically significant number of fish from the relevant body of water, perform a detailed event and age analysis of it because it's considered more accurate than scale dating, and use that as the reference point to cross date and age fish. Over long periods of time, the data from generations of overlapping fish may be used to characterize the body of water and assist in long-term planning and management.

System 1000 may be configured to gather and store, such as in memory 1050, data including, but not limited to, raw imaging, age, and identity data, location, or other information entered into, or gathered by, the computer or processing device or module 1020. The information may be analyzed and output to another device as a display, database, laptop, or printer, for example, for the evaluation and reporting.

System 1000 may be configured to analyze measurements over periods of time, from locations or bodies of water, from particular species of fish, from a particular identified fish, or from other sources of data, such as local weather reports, or DNA data, and provide information to assist in long-term planning and management.

The computer's imaging processor program may also include AI including information from past measurements, or other sources of data such as local weather reports. In this context, AI is a broad term applied to computer systems that are capable of tasks normally associated with human intelligence. In this disclosure, AI may refer to the imaging and computer system that can apply and optimize pattern recognition techniques using machine learning. Machine learning relates to a computing device that uses various imaging techniques and settings to optimize an objective, such as the objective to reliably count event ring bands to determine age. There may be multiple controls or analyses the learning engine can balance, tradeoff and or to optimize or generate to improve the objective.

Referring to FIG. 4C, a photomosaic of an extracted scale 480 is shown. It may be noted that the other edge 481 of the scale is its oldest part. Primary rays 482 are the oldest and extend from the nucleus 483 to the outer edge 481. As the scale grows, additional rays form which do not reach the outer edge and can terminate inside the scale. These are called embedded (or terminated) rays 484. They typically terminate at the inner (nuclei-side) edge of a event ring band 485. As an example, an imaging processing algorithm may be configured to identify the edges of bands by looking for ray terminations. Information such as where the embedded rays are and where they terminate may be learned by a machine learning engine to locate additional bands. The machine learning engine may also generate settings and rules. Settings and rules may be applied to each scale analysis, and between scales to optimize the accuracy of the age analysis process.

The analysis, settings, data including imaging scans, age and information otherwise entered into the user interface may be output to another device as a display, database, laptop, printer for the evaluation and reporting.

The apparatus or fish scale imaging device may also contain indices 1110 use to align the apparatus with the row of scales illustrated in FIG. 3, 310, or the lateral line visible on many fish. Alignment with the lateral line or scale rows may help to improve sampling consistency and supports automated and robotic sampling methods.

Ganoid fish (such as gar) and Cycloid (boney) fish, such as salmon, have different scale structures, but the same methods may be used with different sensor configurations.

One feature or aspect of an embodiment is believed at the time of the filing of this patent application to possibly reside broadly in a fish scale imaging device configured to image a fish scale in situ has a first extension configured and disposed to be placed under the fish scale being imaged and a second extension extends proximate the first extension. A gap space is between the first extension and the second extension, the gap space is sufficient to receive the fish scale. The first extension is movable toward the second extension by an amount sufficient to flatten the fish scale. A light source is configured and disposed to illuminate the fish scale. An optical imager or capacitance sensor is configured and disposed to image or sense patterns within the in situ fish scale.

Another feature or aspect of an embodiment is believed at the time of the filing of this patent application to possibly reside broadly in the fish scale imaging device has a reflecting surface disposed on the first extension

Yet another feature or aspect of an embodiment is believed at the time of the filing of this patent application to possibly reside broadly in the fish scale imaging device further comprising a light splitter configured and disposed to direct light from the fish scale and to the imager or the sensor.

Still another feature or aspect of an embodiment is believed at the time of the filing of this patent application to possibly reside broadly the fish scale imaging device having the capacitance sensor, the capacitance sensor being disposed with the first extension.

A further feature or aspect of an embodiment is believed at the time of the filing of this patent application to possibly reside broadly in an apparatus for detecting Event Rings present in fish scales, comprised of: an electronic scanner that detects event rings present in sclerites including fish scales, and creates a digital data representation of the event rings; and a computer and software which controls a scanning process, analyzes the event rings's digital data and user information to interpret the event rings data.

Another feature or aspect of an embodiment is believed at the time of the filing of this patent application to possibly reside broadly in an apparatus in where the event rings data is interpreted to estimate the age of the scale without requiring the scale to be removed from a fish.

Yet another feature or aspect of an embodiment is believed at the time of the filing of this patent application to possibly reside broadly in an apparatus in where the event rings data is interpreted to generate a unique identifier for a fish without requiring the scale to be removed from the fish.

Still another feature or aspect of an embodiment is believed at the time of the filing of this patent application to possibly reside broadly in an apparatus where the electronic event ring scanner is an optical imager.

A further feature or aspect of an embodiment is believed at the time of the filing of this patent application to possibly reside broadly in an apparatus where the electronic event ring scanner is a capacitance imager.

Another feature or aspect of an embodiment is believed at the time of the filing of this patent application to possibly reside broadly in an apparatus where the event ring scanner may be based on optical, conductivity, ultra-sonic, thickness, or combinations of sensor technologies capable of scanning and digitally detecting event rings.

Yet another feature or aspect of an embodiment is believed at the time of the filing of this patent application to possibly reside broadly in an apparatus with indices for aligning a scanner with a preferred scan direction and preferred sequence of scales.

One feature or aspect of an embodiment is believed at the time of the filing of this patent application to possibly reside broadly in a method of electronically detecting annual event rings present in fish scales and processing the resulting data to estimate the age of the scale.

Another feature or aspect of an embodiment is believed at the time of the filing of this patent application to possibly reside broadly in a method of electronically detecting event rings present in fish scales and processing the resulting data to calculate an age of the scale and optionally a unique identifier code for a fish.

Yet another feature or aspect of an embodiment is believed at the time of the filing of this patent application to possibly reside broadly in the method where event ring data from a plurality of scales can be overlayed in order to replacing missing information, or to add additional information, such as to the ends of the scan data record.

Still another feature or aspect of an embodiment is believed at the time of the filing of this patent application to possibly reside broadly in the method where unique identifier code data from one fish can be overlayed with scan data from future sampling events in order to update the specific fish's unique identifier code.

A further feature or aspect of an embodiment is believed at the time of the filing of this patent application to possibly reside broadly in a fish scale imaging device configured to image a fish scale in situ, the imaging device comprising: a first extension configured and disposed to be placed under the in situ fish scale being imaged; a second extension extending proximate the first extension; a gap space between the first extension and the second extension, the gap space being sufficient to receive the in situ fish scale therebetween; and an imager configured and disposed to image patterns within the in situ fish scale.

Another feature or aspect of an embodiment is believed at the time of the filing of this patent application to possibly reside broadly in the fish scale imaging device configured to substantially flatten the in situ fish scale.

Yet another feature or aspect of an embodiment is believed at the time of the filing of this patent application to possibly reside broadly in the fish scale imaging device, wherein the first extension is movable toward the second extension by an amount sufficient to substantially flatten the in situ fish scale.

Still another feature or aspect of an embodiment is believed at the time of the filing of this patent application to possibly reside broadly in the fish scale imaging device, further comprising a light source configured and disposed to illuminate the in situ fish scale; and wherein the imager comprises an optical imager.

A further feature or aspect of an embodiment is believed at the time of the filing of this patent application to possibly reside broadly in the fish scale imaging device, further comprising a reflecting surface configured and disposed to reflect light from the light source and to the in situ fish scale being imaged.

Another feature or aspect of an embodiment is believed at the time of the filing of this patent application to possibly reside broadly in the fish scale imaging device, wherein the reflecting surface is disposed on the first extension.

Yet another feature or aspect of an embodiment is believed at the time of the filing of this patent application to possibly reside broadly in the fish scale imaging device, wherein the imager comprises a capacitance sensor.

One feature or aspect of an embodiment is believed at the time of the filing of this patent application to possibly reside broadly in the fish scale imaging device, wherein the capacitance sensor is disposed with the first extension.

Another feature or aspect of an embodiment is believed at the time of the filing of this patent application to possibly reside broadly in a method of estimating an age of a fish comprising: placing a first extension of an imaging device under a first in situ fish scale; placing a second extension of the imaging device over the first in situ fish scale and disposing the first in situ fish scale between the first extension and the second extension; imaging the first in situ fish scale; detecting and analyzing event rings in the image of the first in situ fish scale; and estimating the age of the fish based on the detected and analyzed event rings.

Still another feature or aspect of an embodiment is believed at the time of the filing of this patent application to possibly reside broadly in the method, further comprising substantially flattening the first in situ fish scale.

A further feature or aspect of an embodiment is believed at the time of the filing of this patent application to possibly reside broadly in the method, further comprising illuminating the first in situ fish scale with a light source; and wherein the imaging comprises taking an optical image of the first in situ fish scale.

Another feature or aspect of an embodiment is believed at the time of the filing of this patent application to possibly reside broadly in the method, further comprising reflecting light from the light source and to the first in situ fish scale being imaged.

Yet another feature or aspect of an embodiment is believed at the time of the filing of this patent application to possibly reside broadly in the method, wherein the imaging comprises sensing capacitance variations in the first in situ fish scale being imaged.

Still another feature or aspect of an embodiment is believed at the time of the filing of this patent application to possibly reside broadly in the method, further comprising: placing the first extension of an imaging device under a second in situ fish scale; placing the second extension of the imaging device over the second in situ fish scale and disposing the second in situ fish scale between the first extension and the second extension; imaging the second in situ fish scale; detecting and analyzing event rings in the second image of the second in situ fish scale; and wherein the estimating the age of the fish is based on the detected and analyzed event rings of the first in situ fish scale and the second in situ fish scale.

A further feature or aspect of an embodiment is believed at the time of the filing of this patent application to possibly reside broadly in the method, further comprising: optimizing the estimating of the age of the fish, the optimizing comprising: analyzing the imaging of the first in situ fish scale; adjusting at least one of contrast, brightness, focus, illumination wavelength, illumination intensity, noise reduction, and image clarity, based on the analyzing of the imaging of the first in situ fish scale; and suggesting a second imaging.

Another feature or aspect of an embodiment is believed at the time of the filing of this patent application to possibly reside broadly in the method, further comprising saving the imaging of the in situ fish scales and at least one of: acquiring and saving a location of the imaged in situ fish scales; acquiring or identifying and saving a species of fish of the imaged in situ fish scales; individually identifying the fish of the imaged in situ fish scales and saving their identifications; and acquiring and saving a date and seasonal events of the imaged in situ fish scales.

It will be understood that the examples of patents, published patent applications, and other documents which are included below in this application may possibly be used in at least one possible embodiment of the present application. These references, or portions thereof, are hereby incorporated by reference herein: UA93940U, 2014-2017, METHOD FOR DETERMINING THE FISH AGE; UA92970U, 2014 Sep. 10, The device bbp-1 for determining the age of fish; Application UAU201404127U, Method of determining the Fish age; D. W. Willis and Bob Lusk, On Northern Pond, “How Plump is that Fish?”; Guy, C. S., and D. W. Willis, 1995, “Population characteristics of black crappies in South Dakota waters: a case for ecosystem-specific management”, North American Journal of Fisheries Management 15:754-765; R. M. Neumann, B. Murphy, “Evaluation of the Relative Weight (Wr) Index for Assessment of White Crappie and Black Crappie Populations”, Environmental Science, North American Journal of Fisheries Management, 1 Nov. 1991; National Fisheries Research Center, US Fish and Wildlife Service, “Know Your Fish”, Leetown, West Virginia, No. 3; and Werder and Gercilia, AMAZONIANA, VIII, 3, pg 395-420, Kiel, Juni 1984, “Age determination by sclerite numbers, and scale variations in six fish species from the Central Amazon) (Osteichthyes, Characoidei), Ulrich Werder and Gercilia M. Soares”

1. A fish scale imaging device configured to image a fish scale in situ, the imaging device comprising:
a first extension configured and disposed to be placed under the in situ fish scale being imaged;
a second extension extending proximate the first extension;
a gap space between the first extension and the second extension, the gap space being sufficient to receive the in situ fish scale therebetween; and
an imager configured and disposed to image patterns within the in situ fish scale.

2. The fish scale imaging device of claim 1, configured to substantially flatten the in situ fish scale.

3. The fish scale imaging device of claim 2, wherein the first extension is movable toward the second extension by an amount sufficient to substantially flatten the in situ fish scale.

4. The fish scale imaging device of claim 1, further comprising a light source configured and disposed to illuminate the in situ fish scale; and
wherein the imager comprises an optical imager.

5. The fish scale imaging device of claim 4, further comprising a reflecting surface configured and disposed to reflect light from the light source and to the in situ fish scale being imaged.

6. The fish scale imaging device of claim 5, wherein the reflecting surface is disposed on the first extension.

7. The fish scale imaging device of claim 2, wherein the imager comprises a capacitance sensor.

8. The fish scale imaging device of claim 7, wherein the capacitance sensor is disposed with the first extension.

9. A method of estimating an age of a fish comprising:
placing a first extension of an imaging device under a first in situ fish scale;
placing a second extension of the imaging device over the first in situ fish scale and disposing the first in situ fish scale between the first extension and the second extension;
imaging the first in situ fish scale;
detecting and analyzing event rings in the image of the first in situ fish scale; and
estimating the age of the fish based on the detected and analyzed event rings.

10. The method of claim 9, further comprising substantially flattening the first in situ fish scale.

11. The method of claim 9, further comprising illuminating the first in situ fish scale with a light source; and
wherein the imaging comprises taking an optical image of the first in situ fish scale.

12. The method of claim 11, further comprising reflecting light from the light source and to the first in situ fish scale being imaged.

13. The method of claim 10, wherein the imaging comprises sensing capacitance variations in the first in situ fish scale being imaged.

14. The method of claim 9, further comprising:
placing the first extension of an imaging device under a second in situ fish scale;
placing the second extension of the imaging device over the second in situ fish scale and disposing the second in situ fish scale between the first extension and the second extension;
imaging the second in situ fish scale;
detecting and analyzing event rings in the second image of the second in situ fish scale; and
wherein the estimating the age of the fish is based on the detected and analyzed event rings of the first in situ fish scale and the second in situ fish scale.

15. The method in claim 9, further comprising:
optimizing the estimating of the age of the fish, the optimizing comprising:
analyzing the imaging of the first in situ fish scale;
adjusting at least one of contrast, brightness, focus, illumination wavelength,
illumination intensity, noise reduction, and image clarity, based on the analyzing of the imaging of the first in situ fish scale; and
suggesting a second imaging.

16. The method in claim 14, further comprising saving the imaging of the in situ fish scales and at least one of:
acquiring and saving a location of the imaged in situ fish scales;
acquiring or identifying and saving a species of fish of the imaged in situ fish scales;
individually identifying the fish of the imaged in situ fish scales and saving their identifications; and
acquiring and saving a date and seasonal events of the imaged in situ fish scales.
